(19) United States
(12) Patent Application Publication
(10) Pub. No.: US 2016/0012142 A1
(43) Pub. Date: Jan. 14, 2016

(54) System and Method for Parallel Content Delivery and Focus Engine for Content Results

(71) Applicant: Charles J. W. Reed, Jackson, NJ (US)

(72) Inventor: Charles J. W. Reed, Jackson, NJ (US)

(21) Appl. No.: 14/669,048

(22) Filed: Mar. 26, 2015

Related U.S. Application Data
(60) Provisional application No. 61/970,601, filed on Mar. 26, 2014.

(51) Int. Cl. G06F 17/30; H04L 29/06

(52) U.S. Cl. CPC G06F 17/30887; G06F 17/30864; H04L 67/42

(57) ABSTRACT

A method and system for providing a subset of content results to a user is disclosed. The system includes a server, a client, and a network interface. The method includes receiving a request for content results from a client device which specifies how to arrange the search results, analyzing the request to determine how to arrange the content results, requesting content results that corresponding to a focal point; and providing the content results arranged by focal point. Alternatively, if the content is to be delivered individually, the method includes requesting each result separately and providing each result individually. Content results can be processed and provided parallel with each other to provided faster transmission.

### RELATED APPLICATIONS

This application claims the benefit of U.S. Provisional Application No. 61/970,601, filed Mar. 26, 2014.

### FIELD OF THE DISCLOSURE

The present disclosure relates to methods and systems for providing content results to a user. More specifically, the present disclosure relates to.

### BACKGROUND OF THE INVENTION

Server-side scripting (SSS) languages are computer languages designed to allow for the dynamic creation of web content. When a user requests a URL which points to an SSS, the script is executed on the web server and the result is returned to the user. A simple example of this is how a webpage may look on the user's system if said user is logged into the system vs. how the webpage may look on the user's system if they are not logged in. The SSS script would check if the user was logged in or not. If the user was logged in, the content would be displayed. If the user was not logged in, the content may not be displayed and a log in prompt would likely be displayed.

The many server-side scripting languages today do not have any, or have very poor, support for parallel processing/multithreading. Parallel processing allows for data/instructions to be simultaneously processed across multiple systems or CPU cores. Multithreading allows a single CPU core to process different data/instructions in small segments that can give the illusion of parallel processing. This lack of support means that a single SSS may be unable to take advantage of the many systems and CPU's which may be present within the web server cluster.

One of the most common events performed by a SSS which would greatly benefit from the ability to use parallel processing is that of retrieving data from a database. Given the large amount of data required for most content delivery engines, it is not possible to store all of the data on a single server. Therefore, the data has to be stored across many database servers. This means that should a SSS need data from more than one database, it must request the data from one of the databases and wait until the database returns the data before requesting data from any of the other databases. FIG. 1 shows the difference in the speed at which data could be retrieved should a single SSS be able to retrieve data in parallel.

SSS 100, without parallel processing, requests the same data from the same five databases 104 as SSS 102, with parallel processing. Each database 104, on average, requires 2 milliseconds (ms) to return the requested data. However, without parallel processing, script 100 must wait until each database 104 has returned the data requested from it before requesting data from the next database. Therefore, without parallel processing, SSS 100 would take 10 ms to retrieve all of the data. With parallel processing however, SSS 102 would be able to request the required data from all five databases 104 at the same time. Therefore, as the databases are all retrieving and returning the data requested from each within the same 2 ms window, SSS 102 would be able to retrieve all of the data in just 2 ms.

### SUMMARY OF THE INVENTION

A method and system for providing a subset of content to a user is disclosed. The system includes a server, a client, and a network interface. The method includes receiving a request for content results from a client device which specifies how to arrange the content results, analyzing the request to determine how to arrange the content results, requesting content results that corresponding to one or more “focal points”, and providing the content results arranged by focal point or by another classification basis. Alternatively, if the results are to be delivered individually, the method includes requesting each result separately and providing each result individually.

The method allows a user to define one or more pages containing “focal points”. Focal points are defined as a type of displayed result, for example, email regarding a particular subject or the results of a particular search. When a page containing one or more focal points is requested, a server side scripting engine prepares a script for the display of the page dynamically and sends the code to the client side. The script may contain requests for searches on the subject of the focal point to multiple sources. The client side script may make concurrent requests to one or more sources of data. These requests are fulfilled using multiple threads on a remote server, requests to different servers, or a combination of the two.

Servers may keep databases containing results of focal point requests that are common to multiple users. A “focus engine” may keep these databases up to date such that whenever a user requests the display of a focal point, results may be obtained directly from one or more databases.

### BRIEF DESCRIPTION OF THE DRAWING

Embodiments will be described with reference to the figures briefly described as;

FIG. 1 is a diagram that illustrates a comparison of server side scripting with and without parallel processing.

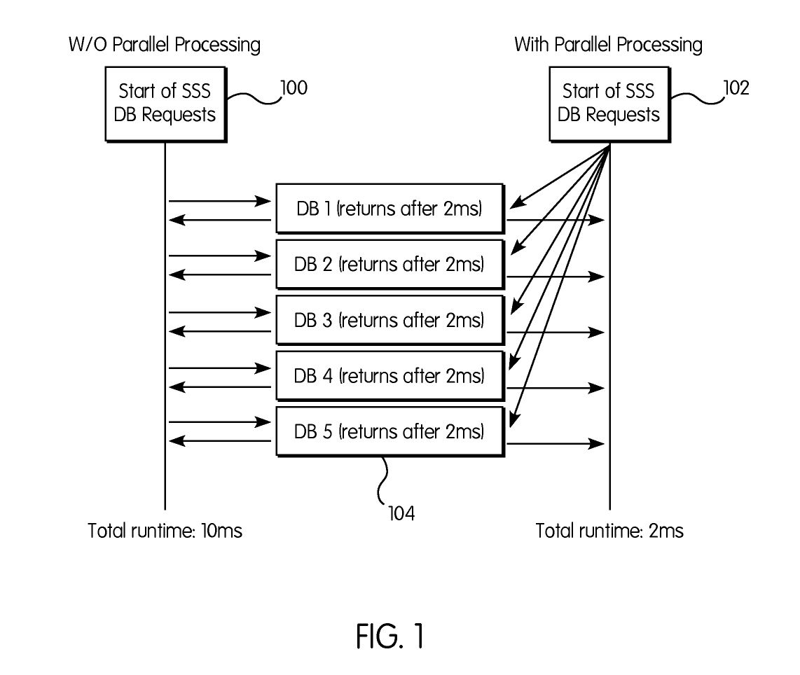

FIG. 2 is a diagram showing the execution path of a JavaScript script during a series during a series of HTTP Requests.

FIG. 3 is a diagram showing focus engine content delivery sorted by focal point.

FIG. 4 is a diagram showing focus engine content delivery sorted by something other than focal point.

FIG. 5 shows the interaction between the user-side elements and the server-side elements when the user requests a focal point page.

FIG. 6 shows the interaction between the user-side elements and the server-side elements when after the requested web page is loaded into the user's web browser.

### DETAILED DESCRIPTION

The present invention addresses the issue of lack of SSS support for parallel processing. A single web server is capable of running numerous SSS's concurrently. Client side scripts (notably JavaScript) can support parallel processing in certain circumstances. One of these is that of an HTTP Request. When a JavaScript script makes an HTTP Request, the script does not wait for the HTTP Request to return a result before continuing its execution path, but branches the script's single thread into two threads. The first thread continues executing along the prior execution path while the second thread waits for the HTTP Request to return a result and then executes any instructions that the coder stated should be executed after the HTTP Request returns before the thread terminates. Therefore, if a script makes a number of HTTP Requests, for SSS's (either the same SSS or different ones), one after the other to a webserver, the webserver is able to process the series of requests in parallel as separate threads or like parallel depending on its hardware. Each of these SSS's can then retrieve the data required from the database, process it, and return the resulting formatted data to the client side script. As client side scripts can create new content or change existing content within a webpage on a user's computing system, when each HTTP Request is returned, the content contained by it can be added to the previously downloaded webpage to fill in the content of the page by the second thread mentioned above.

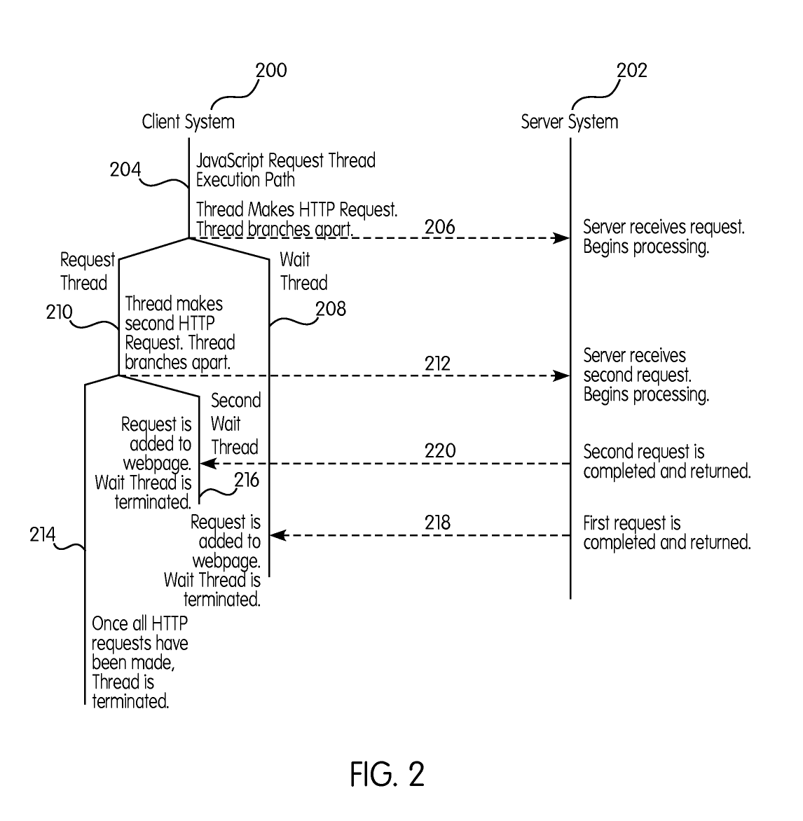

This process is shown in FIG. 2. Client system 200 makes HTTP requests to server system 202. Client system 200 is initially running a single-threaded Java script 204. The Java script makes an HTTP request 206 to server system 202, at which point the single-thread 204 divides into two threads, 208, which is waiting for HTTP request 206 to complete, and 210, which continues processing. Thread 210 eventually makes an additional HTTP request 212 to server system 202, at which point thread 210 splits into thread 214, which continues processing, and 216, which waits for the response to HTTP request 212. At some point, server system 202 responds to HTTP request 206, with response 218 to threads 208, and with response 220 to thread 216. Note that while in the figure the second request is returned first, the responses 218 and 220 to the requests 206 and 212 respectively, are returned as soon as their processing is complete. They could be returned in any order.

As multiple web servers can be called from the client side scripts, each smaller piece of data can be quickly processed at the same time as all of the other pieces. Although this requires more processing to be done at one time then just employing a single web server, the same web servers are able to handle additional requests faster than they otherwise would be able to because the required processing is more quickly finished. This is also true of the databases discussed above. While more data is being requested at a time from the group of databases, the duration of requests is much lower. Therefore the total retrieval time required of all the databases is not noticeably increased.

A “focus engine” is a computing device that allows its user the ability to view many different types of data in a single webpage. These differing types of data include web pages, images, videos, emails, posts from persons or organizations, messages from friends, calendar appointment reminders, advertisements, safely alerts, etc. Additionally, the focus engine can also suggest results to the user based on such results that are popular with other users who have the same or similar focal points as the user. The engine may also return advertisements within the results as the ads are for products/services which are related or unrelated to the terms selected by the user. This allows the user to view any type of content they might desire which meets the criteria specified by the user or the focus engine. The focus engine can take advantage of parallel content delivery to quickly deliver the large variety of content to the user. Without parallel content delivery, the server would have to process each type of content one at a time before sending the completed webpage to the user but with parallel content delivery, the webpage can be sent much more quickly.

A “focal point” specifies different sets of criteria defined or selected by the user. Each focal point contains a content type (search, email, social, etc.) as well as additional options that vary with the content type. For example, for a focal point of type search, some of the options would include search terms and what type of objects (webpages, images, videos, etc.) to search for. When the user reviews their focal points, they are able to view matching objects of content either by focal point, by time discovered, and the like. The user is able to save results, delete unwanted results, post results to social media, email them, comment on them, and the like, all from a webpage containing their defined focal points in a uniform manner, regardless of their content type.

The focus engine is continuously scanning to find new matching results for the user's focal points. As soon as a new matching result is located, it is added to the user's results. The user is therefore able to stay current on a vast number of topics presented by a large number of differing formats all from their own custom webpage or series of web pages. In addition to keeping themselves current, users can also share their findings with others by sharing the content they discovered or by sharing the viewing rights to their pages.

Focal point result content may be stored in one or more server side databases. There are several reasons for this. For example, the amount of content might be too great to be stored within a single database; the results of different content types may have different content storage requirements, the ability to handle a larger number of simultaneous requests for data may be limited, and the like. Databases containing focal point result content may be shared by users who have defined the same or similar focal points. All results for any given focal point should be stored in the same database so that when a request for a subset of the results is made, the script need only request result data from one database. However, the existence of such results should be stored grouped by user and by focal point, as this allows for a more rapid return of data. Even if a user is requesting results shared by another user, in database terms, a user always requests his/her own results. Therefore, by storing all of a user's results within a single database, any number of different results and result types can be retrieved at a single time.

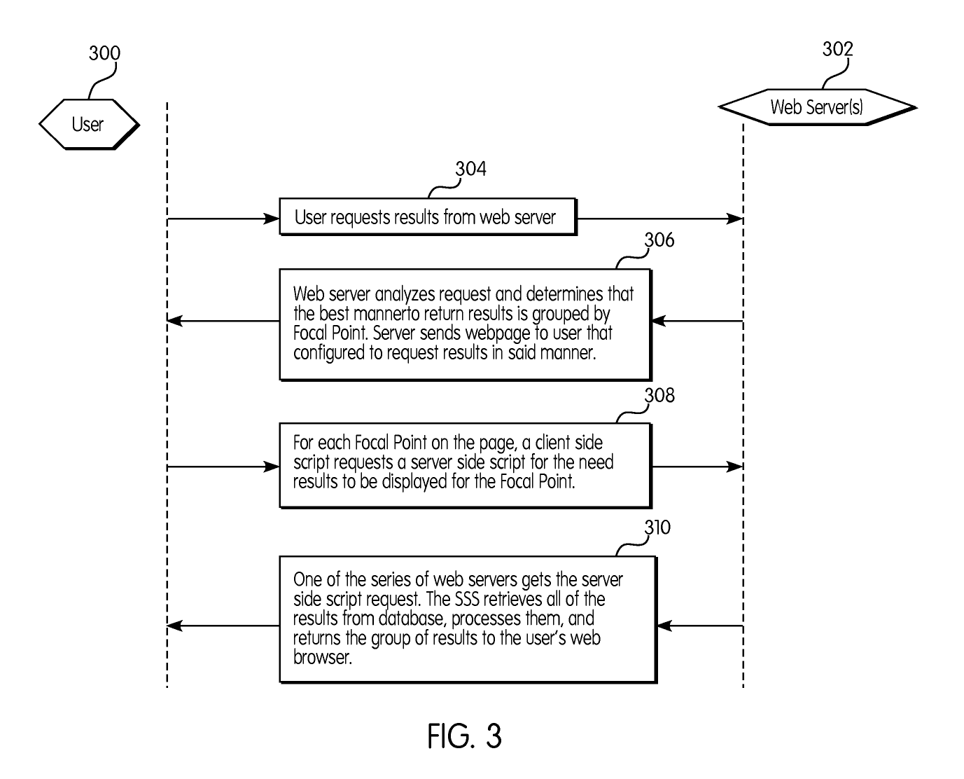

When a user requests a subset of their results, the web server sends the user a webpage containing the basic format of the webpage (i.e., everything but the result content) as well as a custom JavaScript function that will request, using parallel content delivery as shown in FIG. 2, the results from the web server(s). The results are requested in one of two different ways. First, if the results are to be displayed grouped by the focal point that they are from, it is best to return the results in groups of the same focal point. Because the content for all of the results of the same focal point are stored in the same database, they can all be retrieved and processed together faster than if processed separately. This is shown in FIG. 3, where the user is requesting that the results be grouped by pre-defined focal points. User 300 makes a request 304 for a web page containing focal points to web server 302, where the user has previously defined a page containing one or more focal points. Web server 302 analyzes request 304 and determines the best way to return the results is grouped by focal point. Web server 302 then generates code for a web page 306 which is returned to user 300. For each focal point on web page 306, user 300 requests an SSS 308, in a manner that was explained with reference to FIG. 2. Thus, all requests for user 300 get processed in parallel by web server 302. The SSS requests initiated from the web page 306 causes web server 302 to retrieve the focal point result content from a database, process the results, and return the processed results 310 to user 300 as they become available.

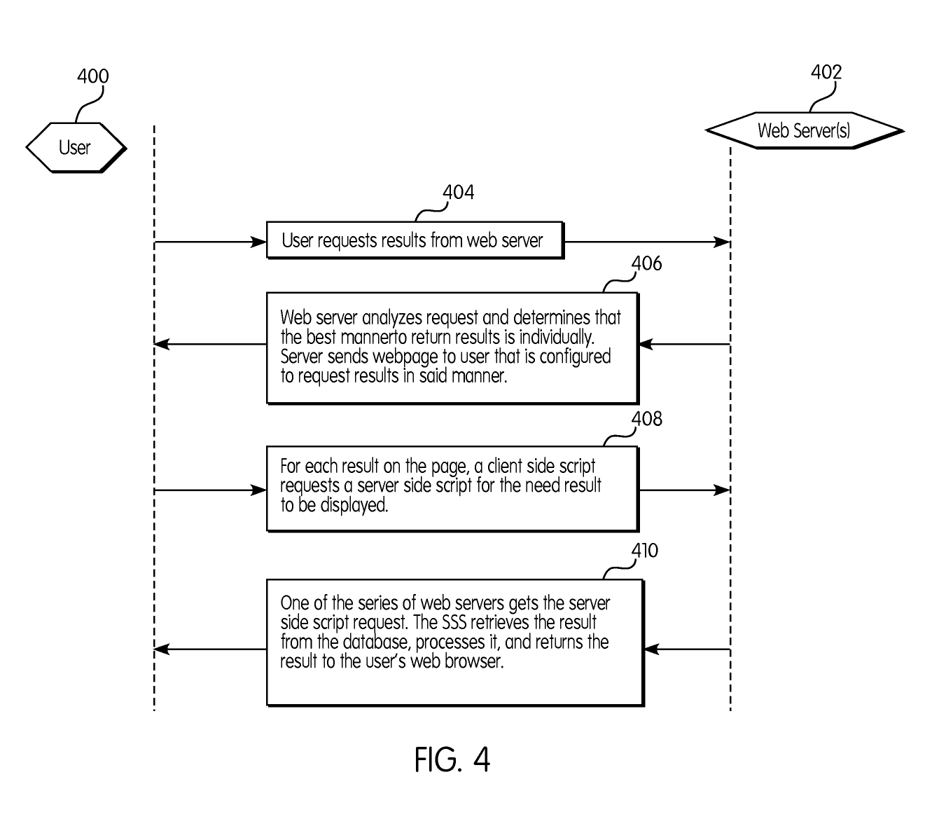

If the results are to be displayed in another way, say alphabetically, it is better to request each result individually as processing and delivering each result separately is not noticeably slower than processing and delivering them in very small groups. This will require more database requests than retrieving the results grouped by focal point, but as additional web servers can be employed to process the results, the duration in which this takes may not be much slower. FIG. 4 shows this process, which is similar to the process shown in FIG. 3. User 400 make a request 404 for results from one or more web servers 402. Each web server 402 analyzes request 404 and determines the best way to return the results, for example, individually. Web server 402 then generates code for a web page 406 which is returned to user 400. For each result on web page 406, user 400, via a client-side script, requests one or more SSS 408, in a manner that was explained with reference to FIG. 2. Thus, all requests for user 400 get processed in parallel by one or more web servers 402. The SSS requests 408 causes one or more web servers 402 to retrieve the result content from databases, process the results, and return the processed results 410 to user 400 as they become available. Knowledge of existence of the results may be required when the initial web page 406 is sent when the results are processed individually, but as such knowledge for a given user may be stored on the same database, this information can be quickly and easily retrieved.

Rather than delivering a webpage that will separately request the results; the results could also be fully processed by the web server as a group and returned as a single webpage with the results already loaded. Although this method is slower, it does not require the use of JavaScript like the methods above. This means that users who cannot or do not want to use JavaScript are still able to use the focal engine, however, this third embodiment of the invention does not employ parallel content delivery.

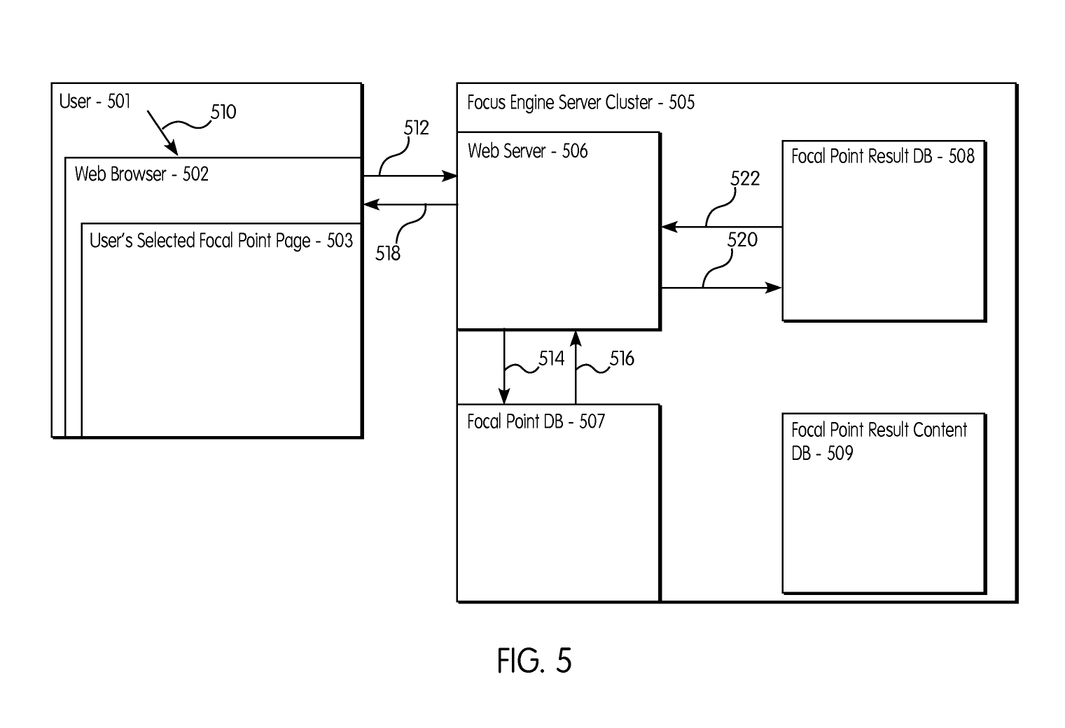

FIG. 5 shows the interaction between the user and the servers of the focus engine when the user wishes to display the results sorted by focal point. User 501 selects one of their pre-defined focal point pages 503 and makes a request 510 to web browser 502 to display it. Browser 502 makes a request 512 to web server 506. When web server 506 receives request 512, it makes a request 514 for the focal point information from focal point DB 507. The focal point information is returned to web server 506 at 516. If request 510 is to have the results grouped by focal point, then web server 506 has all of the data it requires to return the selected page 503 to the user's browser at 518. However, user's request 510 could have been to have the focal point results sorted alphabetically or by some other criteria. If this is the case, then web server 506 must also determine which results should be displayed. Web server 506 therefore must also make a request 520 to focal point result DB 508 to retrieve the matching results at 522. Regardless of how the focal point results are to be displayed, web server 506 then dynamically assembles, using a server side script, the user's selected focal point page. Web server 506 includes server side script generated java script code, which will be run by web browser 502 when the selected focal point page 503 is loaded. The java script code that is generated is dependent on whether the results are to be grouped by focal point or sorted by some criteria. When web server 502 has finished generating focal point page 503, it is returned at 518 to the user's system where it is loaded and displayed by web browser 502.

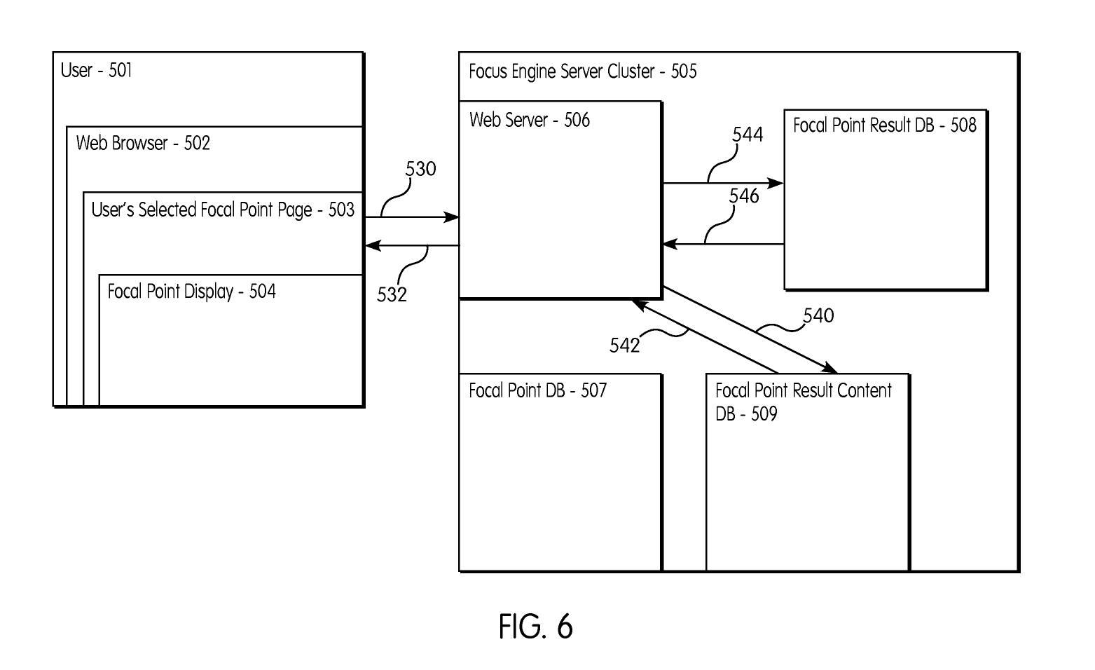

FIG. 6 shows the process by which the focal point result content is retrieved and displayed after the selected focal point page 503 is loaded into the user's web browser 502. Once the user's selected focal point page 503 has been loaded into web browser 502, the java script within the selected focal point page 503 makes one or more HTTP requests 530 to web server 506, depending on how many focal points are defined on the selected focal point page 503. If the results are being displayed grouped by focal point, then each request is for a set of results for that focal point. The number of requests would therefore be equal to the number of focal points on the selected focal point page 503 being viewed by the user. However, if the results are to be sorted by a criteria, then each request 530 is for a single result. For each request 530 received by web server 506, requests 540, 544 are made to focal point result content DB 509, and focal point result DB 508 respectively and the results 542, 546 are returned to web server 506. Web server 506 then creates the necessary code for web browser 502 to correctly display the result and returns the result 532 to web browser 502. Web browser 502 then displays results 504 as part of focal point page 503. During this procedure, focal point result DB 508 is only needed if the request is for a group of focal points, as the system must determine exactly what results should be returned. If the request was only for a single result, then the result to be returned was already determined when the focus engine page was first generated. All the web server 506 need do in that case is to load the content for the result from focal point result content DB 509, and generate the code to return and display the results 532. Once the selected focal point page 503 has received the results 532 of HTTP request 530, it adds the result or set of results 504 to the content displayed in web browser 502.

It should be realized by one of skill in the art that focus engine server cluster 505, shown in FIGS. 5 and 6 may physically comprise multiple web servers and multiple versions of the databases that accompany the present invention. It should also be realized that the invention may utilize an app on a mobile computing platform or other methods to access focus engine 505, and that the invention is not meant to be limited to implementations that use web browser 502 for this purpose. Additionally, one of skill in the art may realize that focal point result DB 508 and focal point result content DB 509 may be updated when other users make requests for similar results, such that results requested by user 501 may already be in databases 508, 509.

We claim:

1. A method for use in a server for providing content to a user, the method comprising:
receiving, on said server, an initial request for content from a client device, wherein said request specifies how to arrange the content;
analyzing said request to determine how to arrange the content;
sending a client-side script to said client device, which, when executed by said client device, generates one or more requests for server-side scripts to retrieve the content;
receiving said one or more of said server-side script requests for retrieval of content from said client device;
executing each of said server-side script requests in a separate thread;
arranging said content in the manner specified in said initial request; and
returning said arranged content to said client device.

2. The method of claim 1 wherein said user has the ability to configure what types of content to be retrieved by selecting for display a page defining one or more focal points thereon.

3. The method of claim 1 wherein said retrieval and arrangement of content is based on the popularity of said content with other users who have requested similar content.

4. The method of claim 1 wherein said retrieval and arrangement of content is based on the content consisting of ads for products/services which are related to the terms selected by the user.

5. The method of claim 1 wherein said initial request is a URL for a page defining one or more focal points thereon.

6. The method of claim 5 wherein said web server, upon receiving said request for a page defining one or more focal points thereon, accesses a database to retrieve information about each of said one or more focal points.

7. The method of claim 6 further comprising the step of generating said client side script, said client side script containing code allowing said client side device to generate multiple requests for content for said one or more focal points.

8. The method of claim 1 wherein said step of executing each of said server-side script requests further comprises the step of accessing a database containing content results for each of said focal points.

9. The method of claim 8 further comprising the step of making a request to a database containing focal point results when the said server side script requests only a subset of the content generated by the said focal point.

10. The method of claim 8 wherein said database containing content results for said focal points is updated each time a user makes a request for a focal point containing the same or similar content results.

11. A system for responding to requests from users for content for focal points to be displayed on a client device, comprising:
a focus engine comprising one or more web servers, each web server having associated therewith:
a. a focal point database, containing information about pre-defined focal points;
b. a focal point result content database, containing content specified by each of said pre-defined focal points; and
c. a focal point result database, specifying a subset of the content to be returned to said client device.

12. The system of claim 11 wherein said one or more web servers receive requests from a client device for a page containing one or more of said pre-defined focal points and in response, generates a client-side script which causes said client device to display said focal points and to generate multiple requests for content for each of said focal points.

13. The system of claim 12 wherein said one or more web servers receive requests for content for each of said focal points and retrieves said content from a database.

14. The system of claim 12 wherein said requests for content specify only a subset of the available content for a focal point and further wherein said one or more web servers retrieve information from a database containing information about the specified subset of content.

15. The system of claim 13 wherein said one or more web servers generate a client side script which causes said client device to display said content for each of said focal points.
